(19) United States
(12) Patent Application Publication
(10) Pub. No.: US 2025/0094912 A1
(43) Pub. Date: Mar. 20, 2025

(54) SECURED PLATFORM FOR MANAGING TRANSPORTATION LOGISTICS LOAD COMPLIANCE

(71) Applicant: Highway App, Inc., Dallas, TX (US)

(72) Inventors: Charles Jordan Graft, University Park, TX (US); Brittany Harlan Graft, University Park, TX (US); Brennan Bailey, Dallas, TX (US); Lawson Hopkins

(21) Appl. No.: 18/960,707

(22) Filed: Nov. 26, 2024

Related U.S. Application Data
(63) Continuation-in-part of application No. 17/816,634, filed on Aug. 1, 2022, now Pat. No. 12,199,974.

(51) Int. Cl. G06Q 10/08; G06Q 40/08

(52) U.S. Cl. CPC G06Q 10/08; G06Q 40/08

(57) ABSTRACT

A system for ensuring secured load compliance by motor carriers comprises an interface element and a memory configured to replaceably store load level compliance records for one or more motor carriers, the memory being further configured to replaceably store one or more sets of load data that is associated with at least one motor carrier of the one or more motor carriers. A processor configured to transmit a request for load information about a predetermined load to a motor carrier, receive load data from the motor carrier responsive to the request for load information, analyze the load data with respect to a load level compliance record associated with the motor carrier and determine if the predetermined load is load compliant responsive to the analysis of the load data with respect to the load level compliance record associated with the motor carrier.

### CROSS-REFERENCE TO RELATED APPLICATION

This application is a continuation-in-part of U.S. patent application Ser. No. 17/816,634, filed Aug. 1, 2022, entitled SECURED PLATFORM FOR MANAGING TRANSPORTATION LOGISTICS (Atty. Dkt. No. HWAI90-00002), which is incorporated by reference herein in its entirety.

### BACKGROUND AND SUMMARY

The last two years have highlighted the supply chain's vital role in the US economy. A key component of the US supply chain is the surface transportation industry which includes Truckload (TL), Less-Than-Truckload (LTL), Parcel, and other segments. The TL segment comprises two components: Private fleets and For-Hire fleets. The history of the For-Hire TL market dates back more than 100 years, with the first motor carriers operating in regional hubs to facilitate the transportation of raw materials and agriculture products. A pivotal moment in the history of For-Hire TL came with the Motor Carrier Act of 1980, which resulted in sweeping deregulation of the trucking industry, including the elimination of governmental restrictions on motor carriers' abilities to contract with new customers and operate in new geographies. Over the next four decades, the For-Hire TL market grew rapidly, and the harrier to entry has steadily declined to allow hundreds of thousands of entrepreneurs to start their own trucking companies and provide a solid foundation for the US supply chain.

Post deregulation, another segment of logistics providers arose: freight brokers and third-party logistics providers (3PLs) (collectively, intermediaries). While they existed in a small form before deregulation, their role and market presence exponentially grew as shippers' access to motor carriers opened up from a few regulated operators to the entire TL carrier base and also smaller motor carriers needed support in finding loads for their business. The percentage of For-Hire TL movements covered by an Intermediary increased from 10% in 2000 to over 40% in 2022 as shippers relied on intermediaries more heavily for reliable sourcing of TL capacity and carriers utilized their load availability to cover more of their trucks and lanes.

Currently, the vast majority of transactions in the TL segment covered by Intermediaries segment are transacted offline without a digital interface. As technology and systems have advanced, the demand for the ability to transact digitally by both Intermediaries and TL carriers has increased. One of the key barriers to the ability to transact digitally is a lack of verifiable digital identity of a carrier attached to its regulatory data. The lack of identity has been compounded by the rapid growth of the scale of the Intermediary industry which exposed two key weaknesses: (1) fraudulent behavior by bad actors leveraging the scale and fragmentation of the TL carrier base and (2) a lack of integrated connectivity for industry participants to respond to the rapidly changing nature of the supply chain daily. Today, intermediaries lack a tool that allows them to authenticate a digital session (i.e. web browser) to the physical authority of a registered motor carrier. This creates friction and the opportunity for bad actors to represent themselves as a registered motor carrier. Additionally, the FMCSA does not provide information on the veracity of a motor carrier's claims of power units and trailer counts. There exists little to no integration between the systems of intermediaries and motor carriers in their network, which means rapidly changing market conditions and load availabilities are not being transmitted in real-time between their systems in a structured format. To provide further resilience and efficiency to the US supply chain, intermediaries and motor carriers need a tool that (1) eliminates fraud related to digital identity, (2) allows for digital integration and the consummation of a relationship, and (3) provides frictionless engagement of a motor carrier to an intermediary's web portal and integration to its systems.

Intermediaries and TL carriers are both regulated entities that require that they establish their operating authority with the FMCSA prior to operating. The FMCSA maintains the authority status of all interstate Intermediaries and TL carriers in the US. However, an industry of unregulated dispatcher services (“Dispatcher Services”) has gained market share in the US. These Dispatcher Services contract with motor carriers to provide them load sourcing services. The unregulated nature and obscurity of the commercial relationship between Dispatcher Services and TL carriers create significant execution and fraud risk in the industry. Today, almost 20% of all attempts to onboard with Intermediaries in the US are executed by Dispatcher Services, and Intermediaries have no visibility or tools to identify when information is being completed by a Dispatcher Service, whether the Dispatcher Service is authorized to work the designated TL carrier, or legal and contact information for the Dispatcher Service apart from the motor carrier. The impact on Intermediaries is increased legal and execution risk if they allow a Dispatcher Service to sign contracts, provide payment details, and dispatch loads without proper authorization from the designated motor carrier.

This disclosure presents a platform for creating a secure, reliable, and efficient connection between motor carriers and intermediaries. The platform is designed to facilitate verification of the previously-described requirements by connecting the digital identity of motor carriers to their physical registered identities with the US. Department of Transportation.

Exemplary elements of the platform include using SMS-based text messages to authenticate users instead of e-mail/password logins. This authentication and verification of the motor carrier allow for a more efficient connection with intermediaries. Likewise, motor carriers can engage with intermediaries with less friction. The platform also reduces overhead by allowing for operations with fewer people and more integration with carrier networks.

### BRIEF DESCRIPTION OF THE DRAWINGS

FIG. 1 depicts a flow chart illustrating importing motor carrier data into a platform from an intermediary's transportation management software (TMS) according to embodiments of the present disclosure.

FIG. 2 illustrates a carrier login.

FIGS. 3A-3C depict a flow chart illustrating the creation of user records on a platform according to embodiments of the present disclosure.

FIGS. 4A-4B depict a flow chart illustrating user onboarding on a platform according to embodiments of the present disclosure.

FIGS. 5A-5B depict a flow chart illustrating the creation of dispatcher-service user records on a platform according to embodiments of the present disclosure.

FIG. 6 depicts various load level compliance functionalities provided by a platform.

FIG. 7 depicts the manner in which a platform may use load information to verify particular load information.

FIG. 8 depicts a flow chart illustrating the manner for determining requirements and insurance pertaining to a particular load.

FIG. 9 depicts various types of cargo requirements.

FIG. 10 depicts a flow chart illustrating the process for determining cargo requirements for a particular load.

FIG. 11 depicts a flow chart illustrating the manner for determining carrier insurance policy and exclusions for a particular load.

FIG. 12 depicts various types of telematic analysis with respect to a load.

FIGS. 13A-13B depicts a flow chart illustrating the manner for analyzing telematics with respect to a load.

### DETAILED DESCRIPTION

This description, with references to the figures, presents non-limiting examples of embodiments of the present disclosure.

Embodiments of the present disclosure relate generally to a platform for improving identity verification and connectivity between motor carriers and intermediaries as well as integration of the TMSs thereof. Such a platform may comprise a data storage element, an interface element, and a data processing element.

In certain embodiments, the data storage element includes some form of reversible memory configured to allow for retrieval, search, or storage of data. Said data may include at least a set of carrier data. The set of carrier data may include identifying information such as a primary key corresponding to a motor carrier. This identifying information may be, for example, a department of transportation (DOT) number, a motor carrier (MC) number, a motor carrier owned or controlled by a citizen or domiciliary Mexico (MX) number, or a Standard Carrier Alpha Code (SCAC).

Within these embodiments, the interface element is configured for communication with the data storage element via the data processing element. The data processing element may be one or more software structures programmed for algorithmic, logical, or other data processing or transmission. The interface element may be accessible on a conventional computing device such as a personal computer or mobile telephone, or alternatively via a web browser or standalone application. As will be described further below, the interface element is configured to accept user input. The data processing element may be configured to relay exchange data between the interface element and the data storage element. Exchange data may include queries of carrier data stored in the data storage element.

### Synchronizing Existing Data.

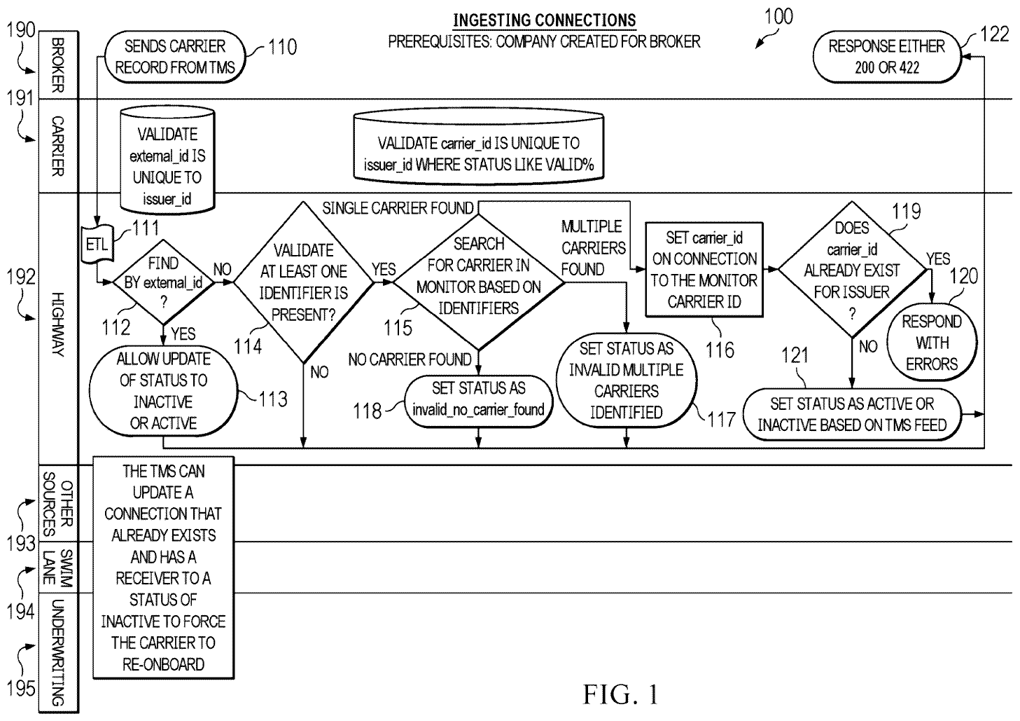

As depicted in FIG. 1, to facilitate the improvement of motor carrier and intermediary connectivity, a platform in accordance with embodiments of the present disclosure may synchronize an intermediary's existing motor carriers. The platform may be configured to communicate with the intermediary's TMS—for example, through an application programming interface (API). Through the interface element, a user intermediary may cause one or more sets of carrier data associated with the intermediary to be communicated to and stored in the data storage element. One or more sets of carrier data may define an intermediary's carrier list within the data storage element. Each set may be a digital representation of a motor carrier currently in the intermediary's motor carriers contained in the intermediary's TMS. Each set may include identifying information as previously described. Additionally, in the set of associated carrier data, the system provides a primary key linked to that specific carrier which translates to one or more federal or state identifiers for that carrier

Once the set of carrier data is received by the platform, the set of carrier data may be validated. The data processing element may be configured to parse the set of carrier data to locate an instance of relevant identifying information which allows the platform to associate the digital representation of the carrier with the carrier's physical identity. If there are no instances or multiple instances of identifying information found, the platform may return an error message to the intermediary. Upon verifying that there is only a single instance of identifying information and linking the set of carrier data to a physical carrier identity, the data processing element may be further configured to verify that the same carrier is not already present in the intermediary's carrier list before storing the record in the data storage element. In the event that an intermediary's set of carrier data is validated, the platform may then store the carrier data as a unique motor carrier record within the data storage element. Further, the platform may be configured to communicate with the intermediary TMS to receive the status of this subject motor carrier connection which may indicate if the carrier has been onboarded, needs to be onboarded, or that the carrier should not be dispatched.

### Creating Secured Connections.

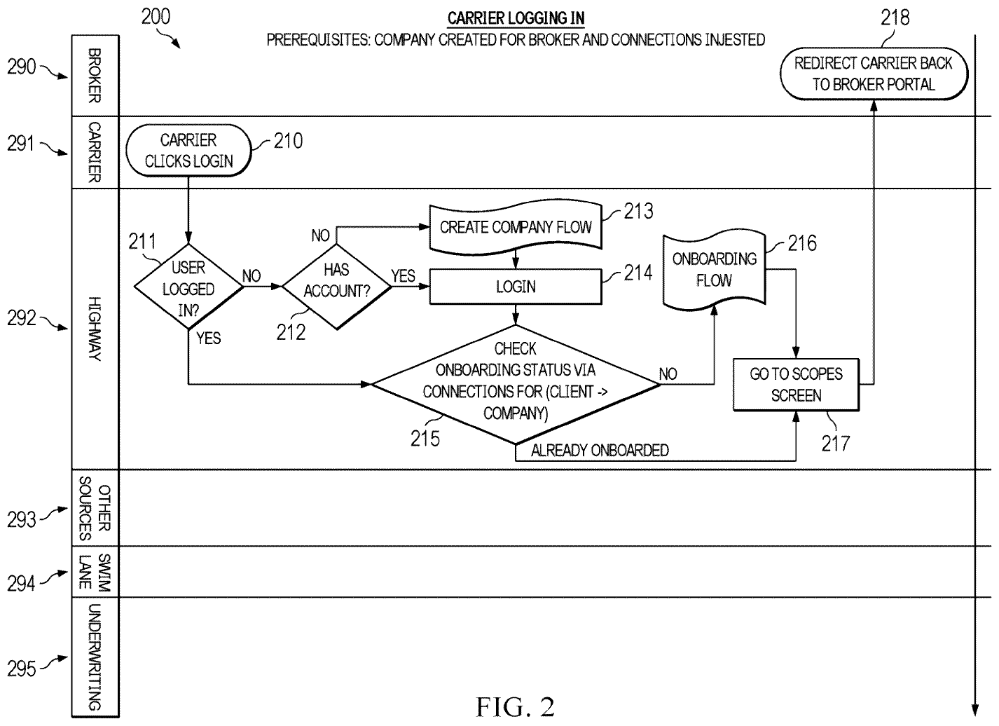

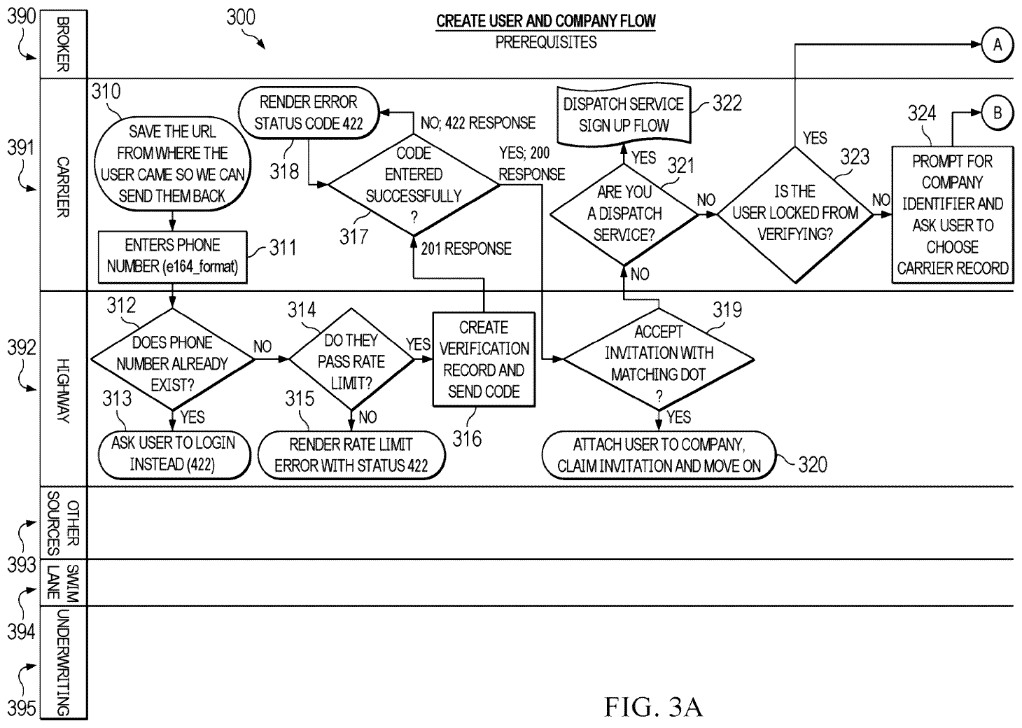

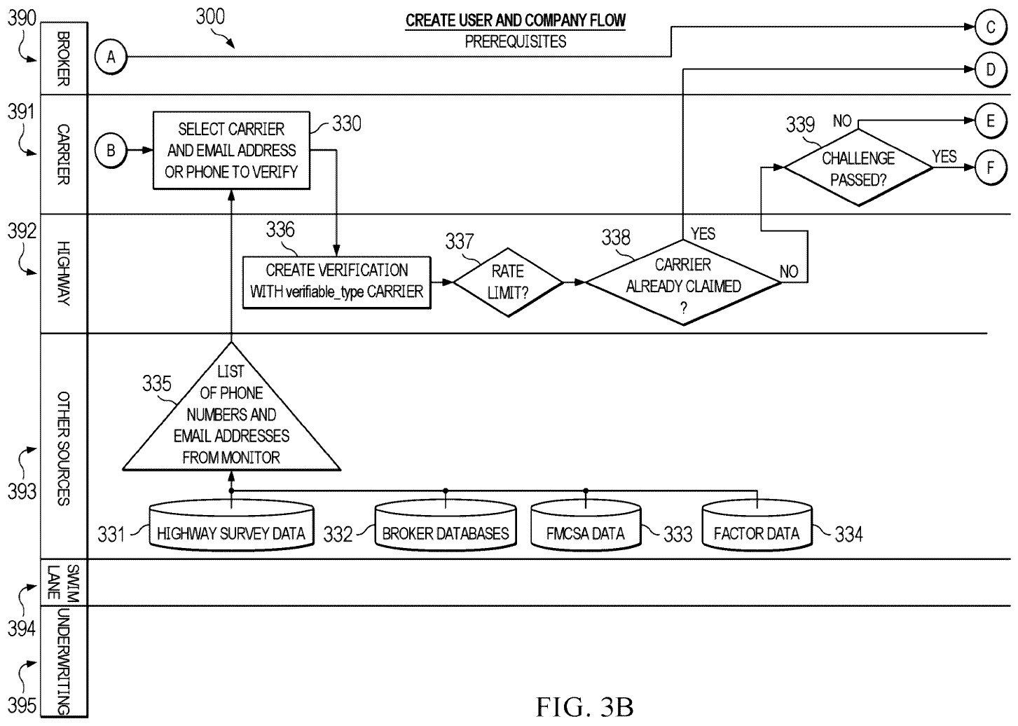

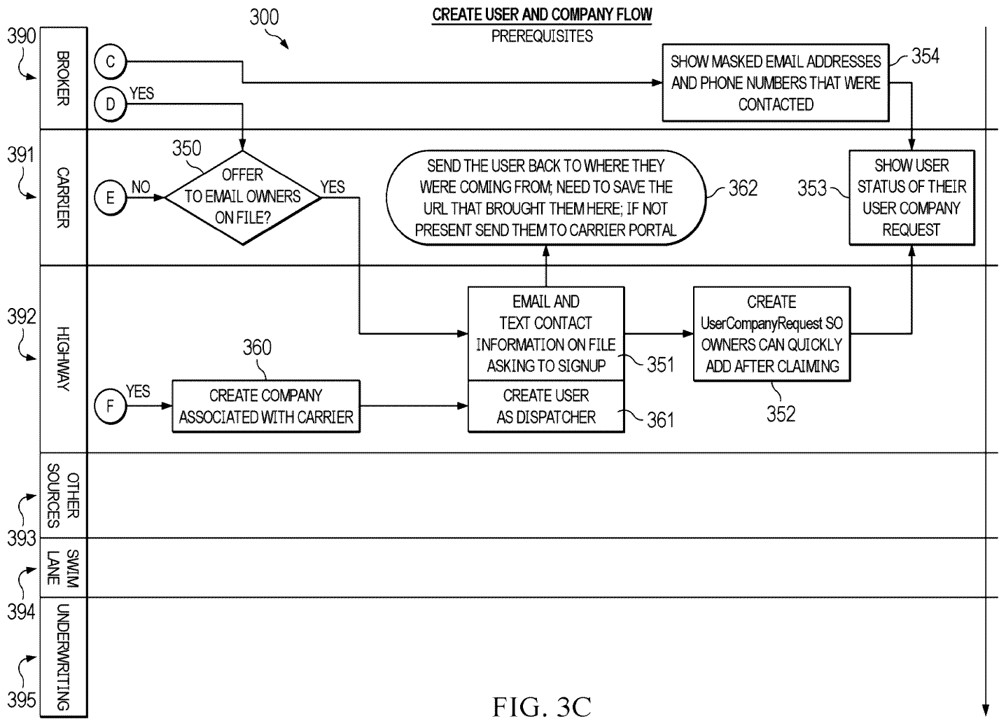

In addition to communicating with an intermediary's TMS, the platform may also be configured to allow motor carriers to generate secure connections with intermediaries, as depicted in FIG. 2. A motor carrier user may interact with the platform via the interface element as embodied in a website. In some embodiments, a motor carrier user may be directed to the interface element via an external link on, for example, an intermediary's website. In such cases, when the motor carrier user is directed to the platform via an external link, the platform may be configured to save the originating URL for later redirection. In these cases, the motor carrier user may be prompted to enter some form of identifying information-such as a DOT or motor carrier number. This information may be passed along to the platform when the external link is clicked. Alternatively, the motor carrier user may be prompted to enter the identifying information when they arrive at the interface element. The platform will verify that the identifying information is valid. This verification may occur by evaluating the entered identifying information against authentication records in the data storage element that originates from external data sources (such as FMCSA or DOT data).

Such data sources are periodically updated—daily in the case of the FMCSA and monthly for DOT data. This updated data may be entered into the data storage element by a system administrator or other personnel as the updated data is received. Once entered into the data storage element, the evaluation may be performed by querying or otherwise retrieving the stored authentication records for comparison with the entered identifying information.

After verification, the platform may then prompt the user to provide an external identity authenticator—such as a phone number or e-mail address. Once entered, the platform may send an authentication code or link to the provided phone number or address. In the case of an authentication code, the motor carrier user may be prompted to enter the code via the interface element to proceed with registration on the platform. If the correct code is entered, a platform account record is created for the motor carrier user The platform account record includes the phone number (or e-mail address) as well as the identifying information. The platform may be configured to allow an external identity authenticator (phone number or e-mail address) to be associated with only a single platform account record.

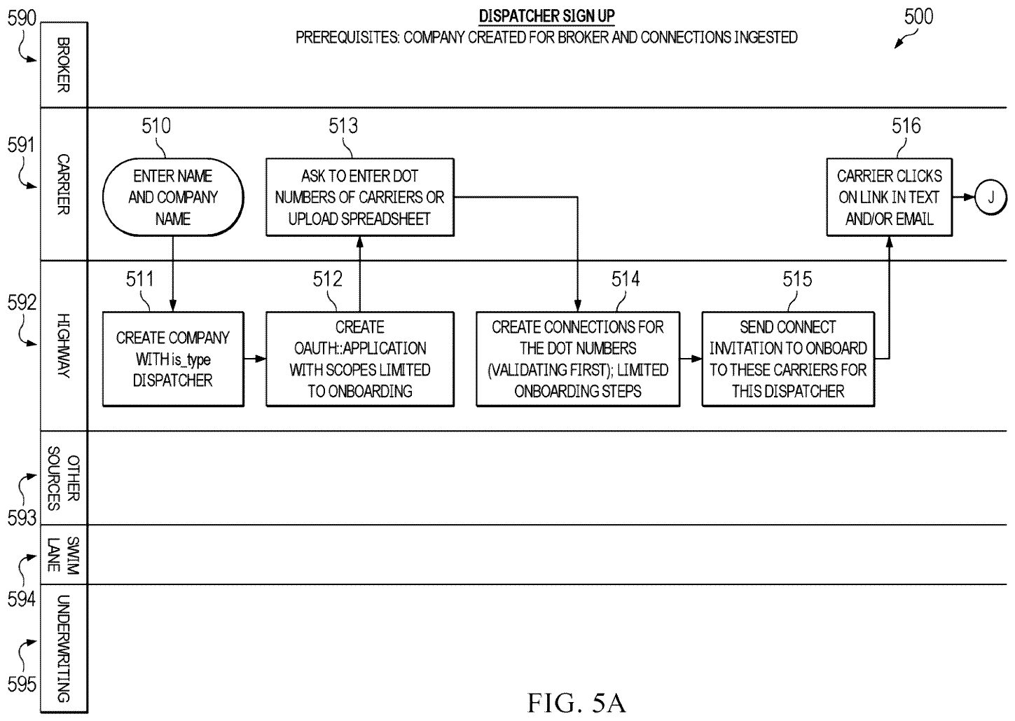

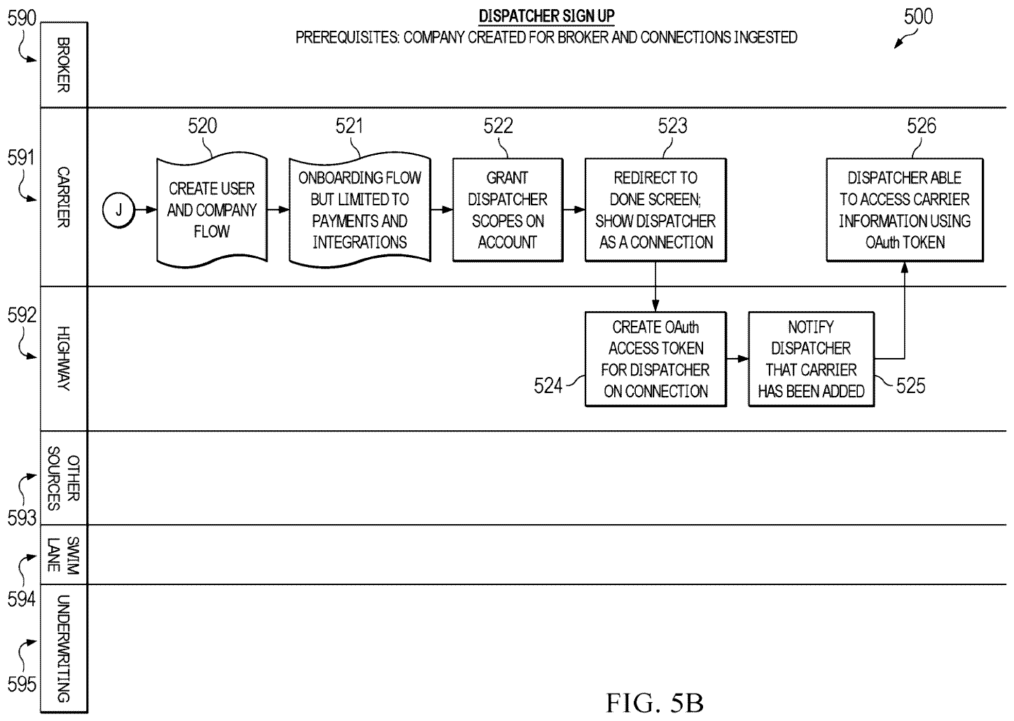

At this stage, the motor carrier user may be asked (for example, via a prompt on the interface element) to confirm their status as a motor carrier or be asked if they are a dispatcher service as shown in FIGS. 5A-5B. If the motor carrier user indicates that they are a dispatcher service, the platform may follow special procedures to verify that the dispatcher service is authorized to operate in collaboration with the designated motor carrier as identified when first accessing the platform. In some embodiments, when the motor carrier user indicates that they are a dispatcher service, the platform may send a confirmation request to the identified motor carrier. The confirmation request may be a link sent to a phone number or e-mail associated with the motor carrier. The platform may be configured to create a dispatcher service company record and to allow further dispatcher service onboarding consistent with the steps to-be described below once the link is accessed or the confirmation request is otherwise fulfilled. If the confirmation request is not fulfilled, no record will be created, and the motor carrier user will not be allowed to onboard.

If the motor carrier user did not indicate that they are a dispatcher service or if the particular embodiment does not require confirmation of the motor carrier user's status, the motor carrier user may then be asked if they are an authorized representative of the motor carrier whose identifying information they have provided. If the motor carrier user indicated that they were an authorized representative of the motor carrier, the platform will present the motor carrier users with a set of motor carrier identity authenticators. This set of motor carrier identity authenticators may be part of the authentication records stored in the data storage element.

A motor carrier authenticator may be a phone number or e-mail address officially registered to the identified motor carrier's physical identity—for example, a phone number or address that is on file with the Department of Transportation, a state DMV, or other sources from which the platform gathers information (such as the external data sources described previously).

The motor carrier user may then select one of the presented motor carrier identity authenticators. An authentication code or link may then be sent to the selected motor carrier identity authenticators. If a code is sent, the motor carrier user may be prompted to enter that code via the interface element. If the code is entered correctly, a company record is created within the data storage element that represents that motor carrier and is associated with the unique external identity authenticator. The company record may comprise data including the identifying information, motor carrier identity authenticators, and a set of authorized persons.

Once an external identity authenticator and a company record are associated, they cannot become unassociated unless a platform administrator authorizes it. For security purposes, a log should be kept of any linking/unlinking of external identity authenticators and company records. Additionally, in some embodiments, once a company record has been associated with an external identity authenticator, it may not be associated with any other. In these embodiments, the first user platform account record holder that is associated with a company record may be allowed to add users to the set of authorized persons within the company record. Users may be added directly by the user platform account record holder or by approval by the user platform account record holder of a request made by a user to join the company's set of authorized persons.

### Onboarding.

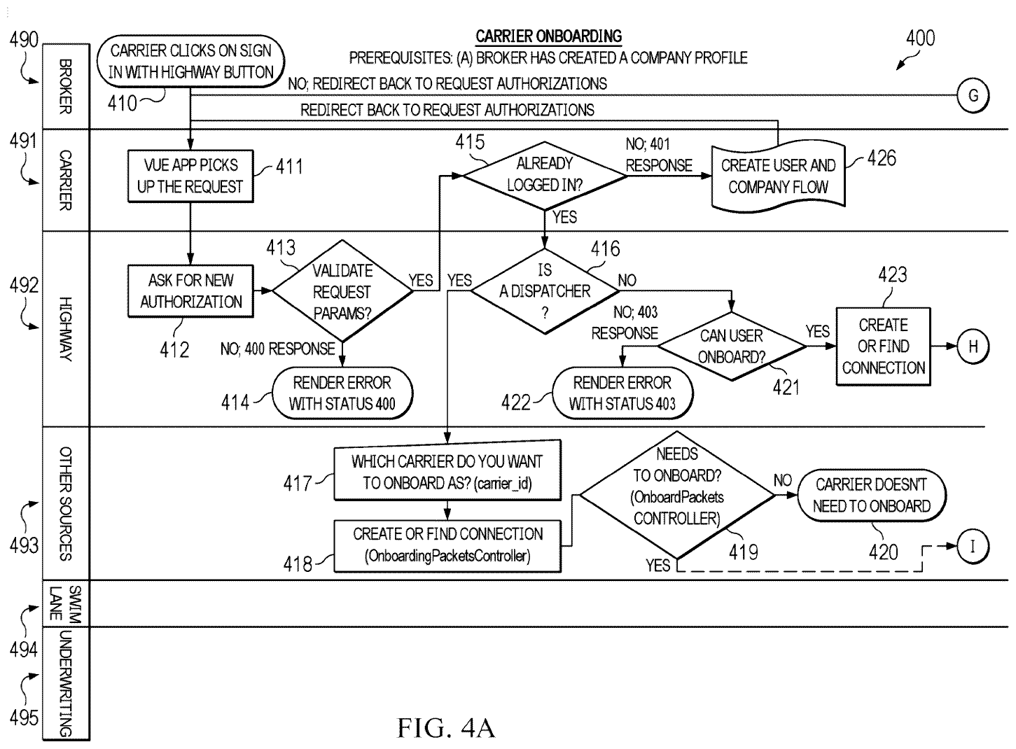

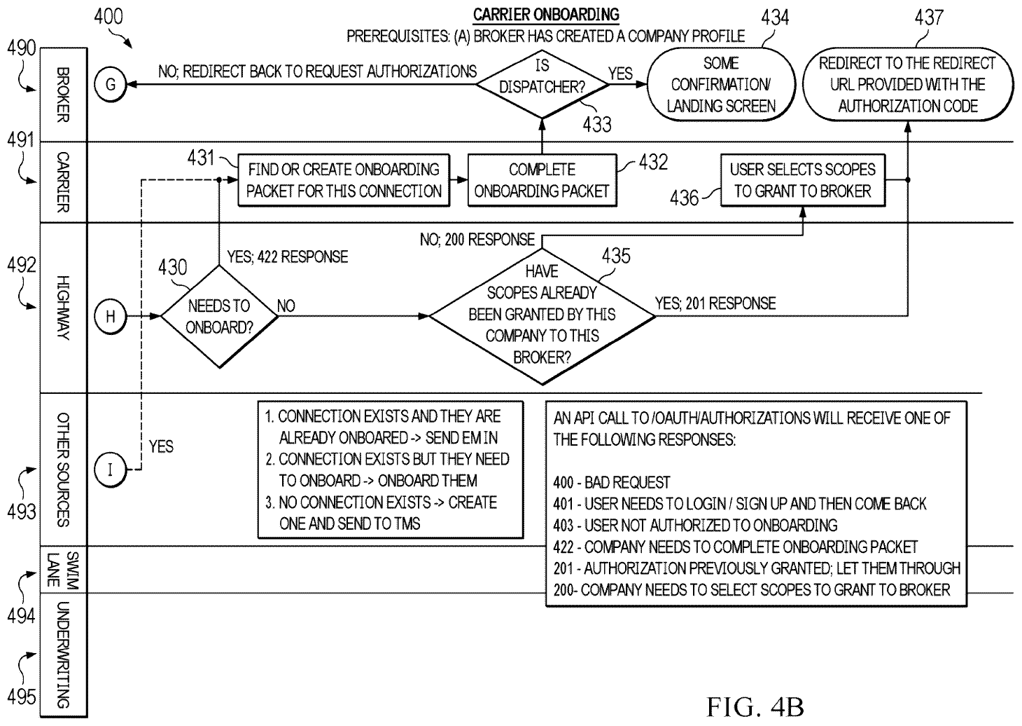

The platform may be further configured to allow the onboarding of a motor carrier to an intermediary as seen in FIGS. 4A-4B. As discussed above, a motor carrier user may access the platform via an external link on an intermediary website. For purposes of this disclosure, an exemplary platform may be referred to as “Highway.” When the motor carrier user visits the intermediary website, the external link may be shown as the text or a button displayed: “Login with Highway.” When clicked, this link will redirect the motor carrier user using the OAuth 2.0 protocol. The redirection to the platform portal uses a combination of query parameters that identify the intermediary with whom the motor carrier user is attempting to connect. The platform then validates the structure of the query parameters against a pre-registered intermediary profile stored in the data storage element of the platform.

Upon validation, the platform checks the motor carrier user's current login status. If the user is not logged in, the user is prompted to enter their login credentials or to create a platform account record as described previously. Once the account record is created, or the user is otherwise logged in, the platform then evaluates if the user can onboard and if the user has authorization under the motor carrier's digital profile to onboard the motor carrier to an intermediary. User authorization may be evaluated by verifying the user's presence in the respective motor carrier's company record's set of authorized persons.

If the user can onboard the motor carrier, the platform will check to see if a connection already exists between the motor carrier and the intermediary. A connection exists if the motor carrier is present in the intermediary's carrier list within the data storage element. If the connection does not exist, the platform may create a new set of carrier data to include in the intermediary's carrier list. The new set of carrier data will not include an external foreign key in order to notify the intermediary's TMS that the motor carrier is new to its system. If the connection does exist, the platform will verify that the motor carrier for whom the user is trying to connect is the same as that within the intermediary's carrier list by comparing the identifying information within the set of carrier data within the intermediary's carrier list to that associated with the user's platform account record.

If the motor earner identity in the user's platform account record and in the intermediary's carrier list is the same, the platform may next determine if the motor carrier needs to onboard by checking the motor carrier status as provided by the intermediary's TMS. If the motor carrier needs to onboard, the platform will prompt the user to complete an onboarding process.

The onboarding process may involve the user creating a core profile, including dispatcher and emergency contact information, lane preferences of the carrier, equipment portfolio of the carrier, and insurance information. After the core profile is completed, the user may be asked to provide intermediary-specific information. The intermediary-specific information may include payment terms and a signature to an intermediary-motor carrier agreement or contract. Additionally, the platform may prompt the user to answer customized questions provided by the intermediary which are not otherwise included in the core profile.

Once the onboarding process is completed, the platform will then evaluate the user's core profile according to an intermediary-defined set of onboarding rules. The intermediary defined set of onboarding rules may take the form of conditions such as minimum insurance coverage, length of the carrier's authority, and safety record requirements. These requirements may be associated with the intermediary's profile. If the motor carrier user's core profile or intermediary-specific information does not satisfy the conditions required by the intermediary-defined set of onboarding rules, the evaluation fails. In the event of a failure, the platform may notify the intermediary of the attempted onboarding, and the intermediary may elect to override the failure and permit onboarding through the platform portal.

Once the user selects which scope to authorize the intermediary to integrate with, they may be redirected to the original intermediary's URL per OAuth 2.0 protocol. The intermediary's systems then continue the OAuth 2.0 protocol by receiving the code provided in the redirect URL. This code is sent along with pre-signed headers using the client ID, which was provided to the intermediary ahead of time during setup, to receive an OAuth access token. This OAuth access token follows the OAuth 2.0 protocol. It may include a signature verifying the issuing identity, an expiration time, an access token itself, and a refresh token. The intermediary's systems may then use this access token to verify the digital identity of the motor carrier and associate it with a physical motor carrier profile both on the platform and within the intermediary's TMS.

As described above, if the physical motor carrier profile does not already exist in the intermediary's system, the platform will create a set of carrier data associated with it and update this data with a callback from the TMS which details the foreign key, originally left blank, for the new connection.

### Load Level Compliance

The above-described carrier information can be linked to specific loads in order to ensure that loads are meeting the necessary transportation requirements with respect to a particular motor carrier. Thus, the Highway platform may further provide load level compliance using a number of various techniques as described more fully herein below to link the motor carriers to specific loads.

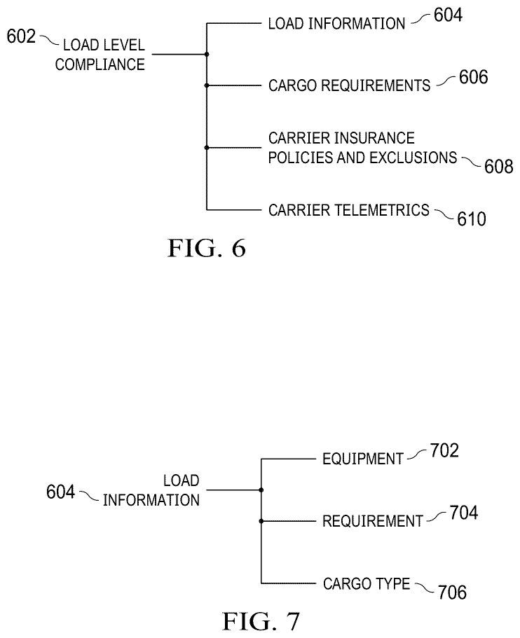

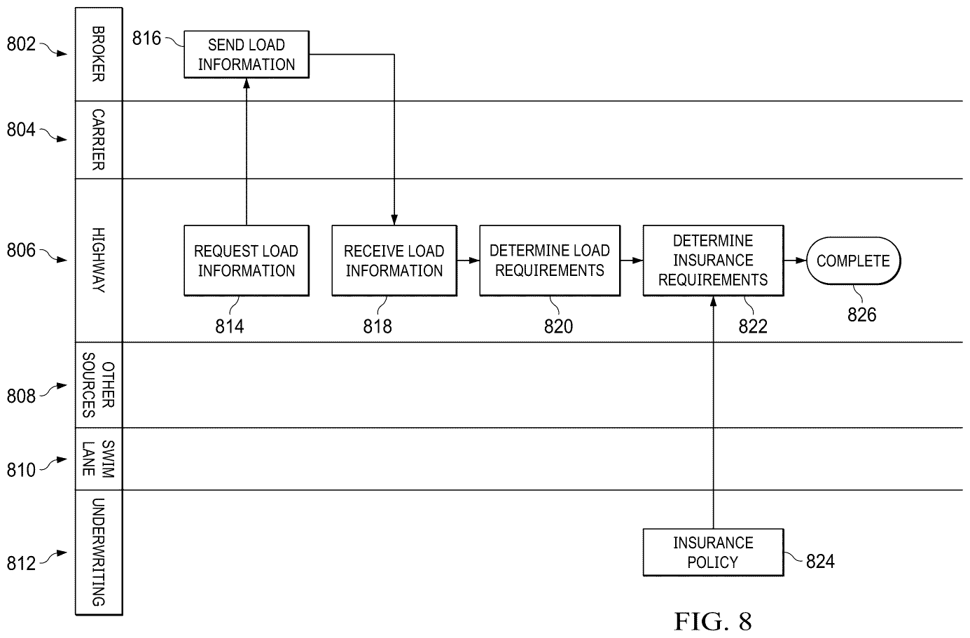

FIG. 6 illustrates various types of information that can be verified with respect to a particular carrier to ensure that load level compliance 602 is maintained. Load level compliance 602 includes a verification of information such as load information 604, cargo requirements 606 (including regulatory requirements), carrier insurance policy and exclusions 608 and carrier telematics 610. The load level compliance 602 is provided by the Highway platform utilizing various forms of data to ensure that carrier loads are compliant. The load level compliance 602 creates a secure environment for freight brokers to tender and run loads. The verification of information is based on a comparison of the carrier load record information with load requirements record information provided by the broker 802 (FIG. 8) or carrier 804.

Referring now to FIG. 7, there is illustrated the various types of load information 604 that may be confirmed to be in load level compliance. The types of load information 604 that may be determined to be in load level compliance include equipment information 702, requirement information 704 and cargo type information 706. The Highway platform collects information about each load including the equipment information 702 which includes information such as whether a refrigerated trailer, flatbed trailer or dry van is required to move the load. The requirement information 704 can include information such as temperature conditions necessary to be maintained for a particular load. Other types of loads may have requirements such as maintaining a dry load, or any other type of environmental condition that must be maintained with respect to the load. The load information 604 can also have cargo type information 706 that indicates the type of cargo that is being transported such as electronics, pharmaceuticals, dry goods, vegetables, livestock, etc. Using this load information 604, the Highway platform can determine what type of requirements and insurance pertain to the load that is being transported such that it can be assured that the particular carrier to be associated with this load meets the requirements and insurance needs of the load. The determination of whether particular load and insurance requirements are met are based on a comparison of the carrier and load record information provided by provided by the broker 802 (FIG. 8) or carrier 804 and underwriters 812.

Referring now to FIG. 8, there is illustrated the process by which the Highway platform 806 can obtain load information from a load broker 802. The Highway platform 806 initially requests at 814 load information associated with a particular load from a broker 802. Responsive to the requests, the broker 802 sends load information at step 816 back to the Highway platform 806. The Highway platform 806 receives the provided load information at 818. The Highway platform 806 utilizes the received load information 818 from the broker 802 to determine the load requirements at 820 that are associated with the particular load being analyzed by the platform 806. Further at 822, the Highway platform 806 may utilize load information provided from the broker 802 along with insurance policy information 824 provided from an underwriter 812 to determine the insurance requirements associated with a particular load. The process is completed at 826 where the determined load requirements and insurance information may be provided to the appropriate parties to confirm the carrier associated with a particular load meets the necessary requirements.

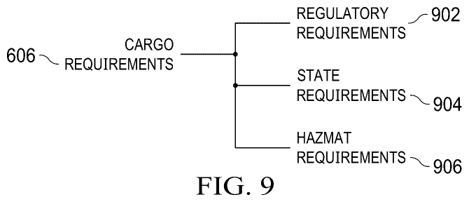

Referring now to FIG. 9, there is illustrated the manner in which cargo requirements 606 associated with a particular load may be analyzed by the Highway platform 806 in order to enforce the various cargo requirements associated with the transportation of the load. The Highway platform 806 checks regulatory requirements 902 to ensure that all of the federally regulated standards associated with a particular load are being met. The Highway platform 806 may also analyze state regulatory requirements as various states have their own set of regulation for the transportation of loads. For example, in California equipment must be CARB or CARB TRU compliant meaning that equipment must meet the emission standard set by the California air resource board (CARB). The Highway platform 806 may additionally determine hazmat requirements 906 that must be met with respect to a particular load and provide this information to the motor carrier or confirm that the carrier can meet the hazmat requirements. The determination of whether particular requirements are met are based on a comparison of the carrier load record information with Federal, State or hazmat requirements record information provided by other sources 808.

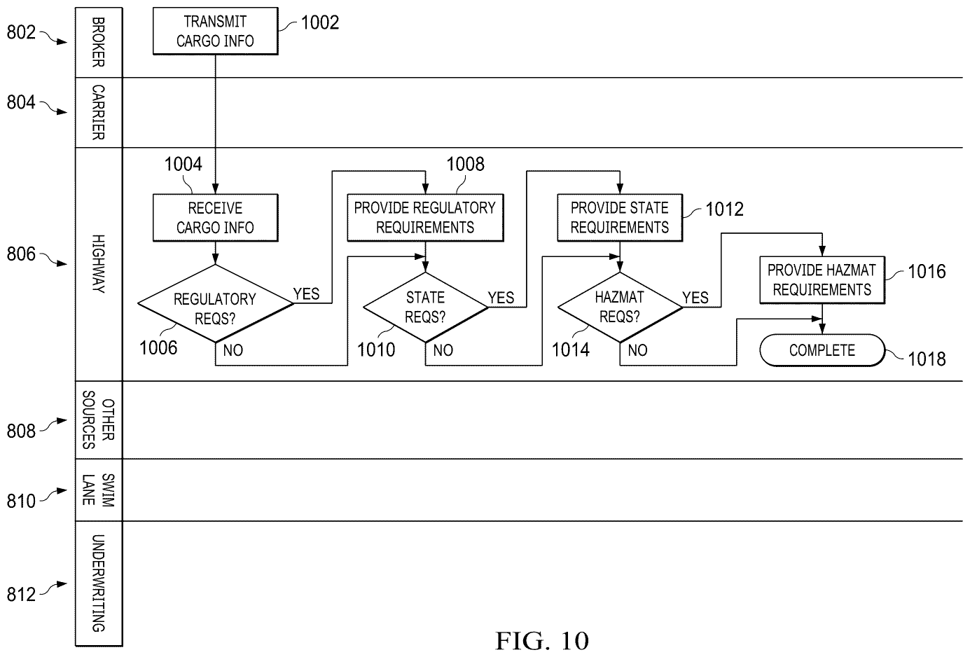

Referring now to FIG. 10, there is illustrated a flow diagram describing the process by which the Highway platform 806 can determined cargo/load requirements 606. Initially the broker 802 transmits cargo information 1002 to the Highway platform 806 that receives the cargo information at 1004. The Highway platform 806 utilizes the received cargo information 1004 to determine at 1006 if there are any regulatory requirements that are associated with the proposed cargo. If inquiry step 1006 determines there are associated regulatory requirements, the necessary regulatory requirements are provided to the carrier at 1008. If no regulatory requirements are determined or after provision of the determined regulatory requirements at 1008, inquiry step 1010 determines if there are associated state requirements with respect to the load. If inquiry step 1010 determines that state requirements are associated with the load, the necessary state requirements are provided at 1012 to the carrier. Inquiry step 1014 then determines if there are any hazmat requirements associated with the load. If so, the necessary hazmat requirements are provided at 1016 to the carrier and the process is completed at 1018. If no hazmat requirements are required the process completes at 1018.

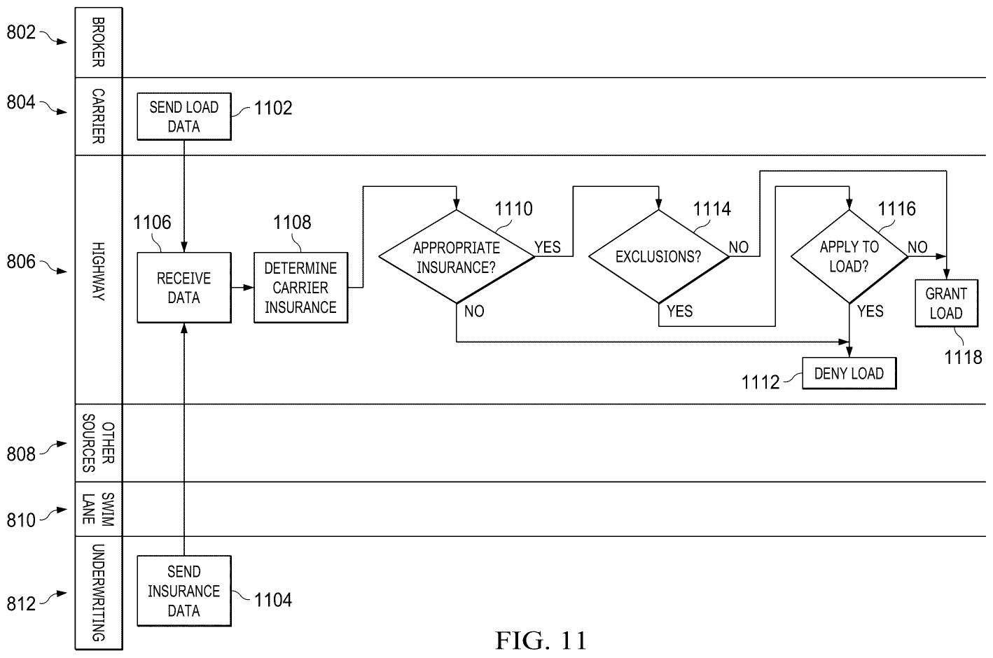

Referring now to FIG. 11, there is illustrated a flow diagram of the process for determining carrier insurance policies and exclusions. Highway platform 806 processes the insurance coverages of each carrier and determines that the carrier has the appropriate insurance coverage and amounts for the loads they are attempting to transport. The Highway platform 806 may additionally check for any exclusions to the carrier's cargo insurance policy. For example, a carrier 804 may have an exclusion for electronics, or a certain type of commodity that is being transported. Carrier's policies may also have exclusions that pertain to certain states. The Highway platform 806 can effectively prevent unpaid cargo claims by ensuring that the carriers 804 are not engaging in activities or hauling loads for which they have exclusions.

In the process of FIG. 11, the carrier 804 sends load data at 1102 to the Highway platform 806 and the underwriter 812 sends insurance data at 1104 to the Highway platform 806. The Highway platform 806 receives at 1106 the load data from the carrier 804 and the insurance data from the underwriter 812. This information is used to determine at 1108 the available level of carrier insurance with respect to the load for the carrier 804. The Highway platform 806 determines at 1110 whether the carrier 804 has the appropriate level of insurance to transport the particular load in question. If not, the carrier 804 is denied the load at 1112. If the carrier 804 does have the appropriate level of insurance, the Highway platform 806 determines if particular exclusions apply to the carrier at 1114. If exclusions are identified, it is determined at 1116 whether the determine exclusions apply to the load in question. If so, the carrier 804 is denied the load at 1112. If the exclusions do not apply to the load, the load is granted at step 1118.

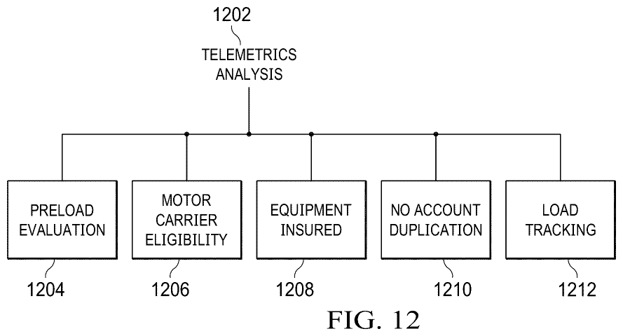

Referring now to FIG. 12, there is illustrated the manner in which the Highway platform 806 may use telematics analysis 1202. Telematics uses GPS and onboard diagnostics to monitor the location operation and function of vehicles, trucks and other assets of a carrier 804. Telematic systems can gather a variety of data on the operation of a vehicle. The Highway platform 806 performs an initial preload evaluation 1204 of the motor carrier 804 Telematics data to determine which loads the carrier is able to view on their digital load boards, digital experiences or other digital devices. The Highway platform 806 also uses the Telematics data of the motor carrier vehicle to determine the motor carrier eligibility 1206 to receive information about a particular load. The Highway platform 806 may proactively prevent sensitive load information that can be used by bad actors to steal a load from being sent to a carrier 804 until the carrier has crossed a particular perimeter break. For example, a motor carrier 804 may receive load information once they are within 50 miles of a pickup location.

The Highway platform 806 receives the telematic data received from a motor carrier vehicle to determine if the equipment to be used by the carrier 804 is insured at 1208 by determining if the equipment is listed on the carrier's scheduled insurance policy. The Highway platform 806 also may confirm no account duplication 1210 by ensuring that the Telematic account that is only connected to one carrier is not shared or connected with another carrier. The sharing of Telematic accounts can be one sign of criminal activity allowing one carrier to impersonate another carrier. Finally, the Highway platform 806 can periodically ping a Telematic device on a vehicle or trailer of a carrier 804 throughout the progress of a load transport to ensure that the load do not go off route or drop-off a load at a different location which may be linked to theft using load tracking capabilities 1212.

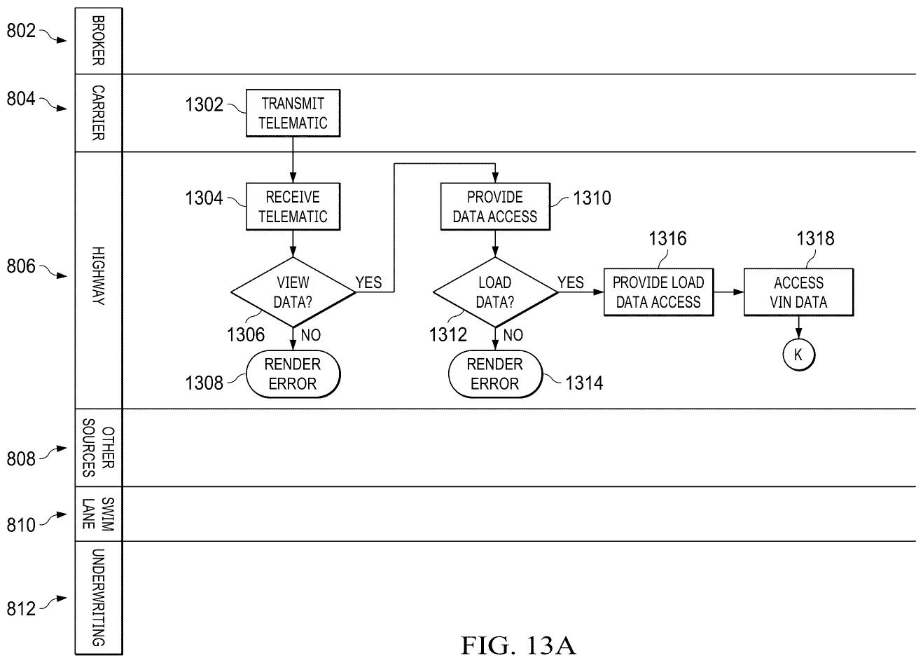

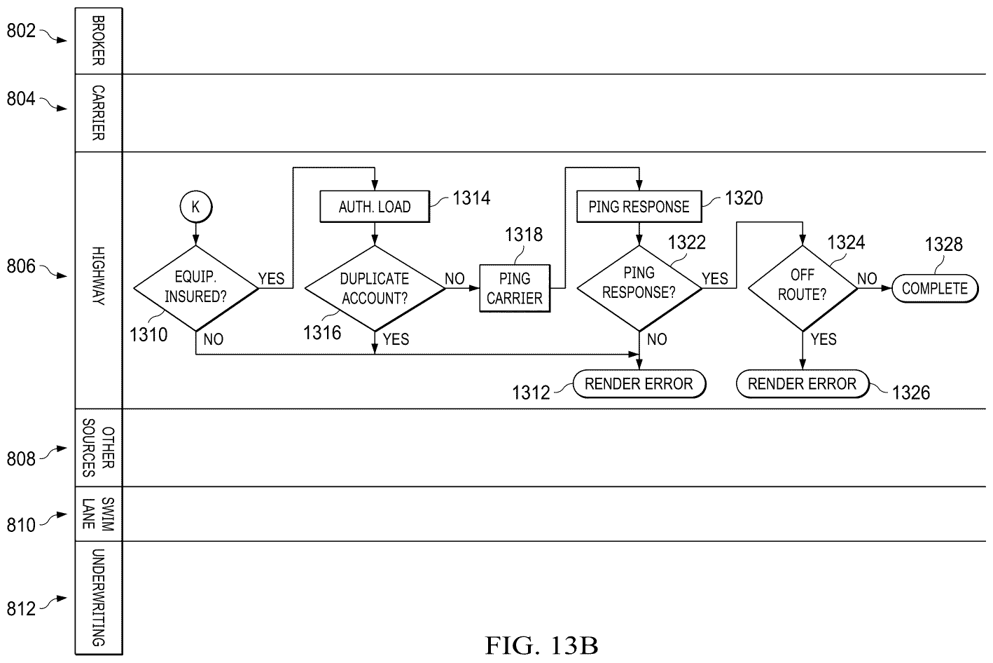

Referring now to FIGS. 13A-13B, there is illustrated a flow diagram of the process by which the Highway platform 806 analyzes Telematic data. The carrier 804 transmits its Telematic data at 1302 from the carrier to the Highway platform 806 which receives the Telematic data at 1304. The Highway platform 806 analyzes the received Telematic data at 1306 to determine if the carrier is able to view Telematic data on their digital load boards or other digital devices. If not, an error is indicated at step 1308. If the Telematic data may be viewed on digital devices, the carrier 804 is provided access to the Telematic data at 1310 for display on the digital devices of the carrier. Next, the Highway platform 806 determines if the carrier 804 is able to receive load data at 1312. If not, an error is generated at step 1314. If load data may be received by the carrier 804, the carriers is provided with load data access at step 1316.

The Highway platform 806 will then access insurance data at 1318 that is provided with the Telematic data such that the Highway platform 806 may determine if the carrier equipment is insured at 1320. If the carrier equipment is not insured, an error message is rendered at 1312. If the carrier equipment is insured, the load is authorized for the carrier at 1314. The platform 806 determines at 1316 if duplicate accounts exist for a carrier 804 such that information is shared or connected with another carrier. If accounts are duplicated, a potential fraud condition is possible and an error or fraud notification is rendered at 1312. If no duplicate accounts exist, control passes to 1318 wherein the carrier vehicle may be periodically pinged by the Highway platform 806. The carrier vehicle generates a ping response 1320 responsive to the ping from the Highway platform 806. The Highway platform 806 determines if there is a ping response at 1322 and if not renders the error message at 1312. If a ping response is detected, the Highway platform 806 determines if the carrier vehicle is located on a designated route for the load based upon the vehicle position indicated by the ping response. If the carrier vehicle is not located on the designated route, an error messages generated at 1326 to warn of a theft or fraud, otherwise the process is completed 1328.

By associating the load level information between a particular carrier and a particular load as described hereinabove, the Highway platform 806 creates a secure environment for freight brokers 802 to run loads. The Highway platform 806 conduct various checks against received by the platform ensure that carriers 804 follow all proper protocols when transporting freight.

Persons of ordinary skill in the art would recognize that the connection and integration of systems to the platform may vary depending on the participating carriers and intermediaries such that the scope of this disclosure is not limited to only those particular configurations of systems described in the various embodiments.

What is claimed is:

1. A system for ensuring load compliance by motor carriers comprising:
an interface element;
a memory configured to replaceably store load level compliance records for one or more motor carriers, the memory being further configured to replaceably store one or more sets of load data that is associated with at least one motor carrier of the one or more motor carriers;
a processor configured to:
transmit a request for load information about a predetermined load to a motor carrier;
receive load data from the motor carrier responsive to the request for load information;
analyze the load data with respect to a load level compliance record associated with the motor carrier; and
determine if the predetermined load is load compliant responsive to the analysis of the load data with respect to the load level compliance record associated with the motor carrier.

2. The system of claim 1, wherein the processor is further configured to determine what type of transport vehicle requirements and insurance are required for the predetermined load with respect to the motor carrier responsive to the load level compliance record for the motor carrier and the load data for the predetermined load.

3. The system of claim 1, wherein the processor is further configured to determine cargo requirements that must be met for the motor carrier to transport the predetermined load responsive to the load level compliance record for the motor carrier and the load data for the predetermined load.

4. The system of claim 1, wherein the processor is further configured to determine whether the motor carrier has proper insurance coverage for the predetermined load responsive to the load level compliance record for the motor carrier and the load data for the predetermined load.

5. The system of claim 4, wherein the processor is further configured to determine if any motor carrier insurance policy exclusions apply to the predetermined load responsive to the load level compliance record for the motor carrier and the load data for the predetermined load.

6. The system of claim 1, wherein the processor is further configured to:
perform a telematic analysis of the motor carrier responsive to the load level compliance record for the motor carrier;
determine if the motor carrier is able to view load information on the predetermined load on a digital output device responsive to the telematic analysis; and
transmit the load information on the predetermined load to the digital output device responsive to a determination that the motor carrier is able to view the load information on the predetermined load.

7. The system of claim 1, wherein the processor is further configured to:
perform a telematic analysis of the motor carrier responsive to the load level compliance record for the motor carrier;
determine if the motor carrier is able to receive the load data on the predetermined load responsive to the telematic analysis; and
transmit the load information to the motor carrier responsive to a determination that the motor carrier is able to receive the load information on the predetermined load.

8. The system of claim 1, wherein the processor is further configured to:
determine a predetermined distance from a predetermined pickup point of the predetermined load that the motor carrier is able to receive the load information on the predetermined load responsive to the load level compliance record for the motor carrier;
determine if the motor carrier is within the predetermined distance of the predetermined pickup point; and
transmit the load information to the motor carrier responsive to a determination that the motor carrier is within the predetermined distance from the predetermined pickup point of the predetermined load.

9. The system of claim 1, wherein the processor is further configured to:
perform a telematic analysis of the motor carrier responsive to the load level compliance record for the motor carrier;
determine if a telematic account is shared with a second motor carrier other than the motor carrier responsive to the telematic analysis; and
deny the predetermine load to the motor carrier responsive to a determination that the telematic account is shared with a second motor carrier.

10. The system of claim 1, wherein the processor is further configured to:
determine a VIN number for a vehicle of the motor carrier that will transport the predetermined load responsive to the load level compliance record for the motor carrier;
determine if the vehicle of the motor carrier is insured to transport the predetermined load responsive the VIN number for the vehicle and insurance data for the motor carrier; and
granting the predetermined load to the motor carrier responsive to the determination of whether the vehicle of the motor carrier is insured to transport the predetermined load.

11. The system of claim 1, wherein the processor is further configured to:
periodically ping a telematic device associated with a vehicle of the motor carrier transporting the predetermined load;
receive a response ping responsive to a ping to the telematic device; and
determine if the vehicle is off route for delivery of the predetermined load responsive to the response ping.

12. A method for ensuring load compliance by motor carriers comprising:
transmitting a request for load information about a predetermined load to a motor carrier from a load compliance platform;
receiving load data from the motor carrier responsive to the request for load information;
analyzing the load data with respect to a load level compliance record associated with the motor carrier; and
determining if the predetermined load is load compliant responsive to the analysis of the load data with respect to the load level compliance record associated with the motor carrier.

13. The method of claim 12, wherein the step of determining further comprises determining what type of transport vehicle requirements and insurance are required for the predetermined load with respect to the motor carrier responsive to the load level compliance record for the motor carrier and the load data for the predetermined load.

14. The method of claim 12, wherein the step of determining further comprises determining cargo requirements that must be met for the motor carrier to transport the predetermined load responsive to the load level compliance record for the motor carrier and the load data for the predetermined load.

15. The method of claim 12, wherein the step of determining further comprises determining whether the motor carrier has proper insurance coverage for the predetermined load responsive to the load level compliance record for the motor carrier and the load data for the predetermined load.

16. The method of claim 12, wherein the step of determining further comprises:
performing a telematic analysis of the motor carrier responsive to the load level compliance record for the motor carrier;
determining if the motor carrier is able to view load information on the predetermined load on a digital output device responsive to the telematic analysis; and
transmitting the load information on the predetermined load to the digital output device responsive to a determination that the motor carrier is able to view the load information on the predetermined load.

17. The method of claim 12, wherein the step of determining further comprises:
performing a telematic analysis of the motor carrier responsive to the load level compliance record for the motor carrier;
determining if the motor carrier is able to receive load data on the predetermined load responsive to the telematic analysis; and
transmitting the load information to the motor carrier responsive to a determination that the motor carrier is able to receive the load information on the predetermined load.

18. The method of claim 12 further comprising:
determining a predetermined distance from a predetermined pickup point of the predetermined load that the motor carrier is able to receive the load information on the predetermined load responsive to the load level compliance record for the motor carrier;
determining if the motor carrier is within the predetermined distance of the predetermined pickup point; and
transmitting the load information to the motor carrier responsive to a determination that the motor carrier is within the predetermined distance from the predetermined pickup point of the predetermined load.

19. The method of claim 12, wherein the step of determining further comprises:
performing a telematic analysis of the motor carrier responsive to the load level compliance record for the motor carrier;
determine if a telematic account is shared with a second motor carrier other than the motor carrier responsive to the telematic analysis; and
deny the predetermine load to the motor carrier responsive to a determination that the telematic account is shared with a second motor carrier.

20. The method of claim 12, wherein the step of determining further comprises:
determining a VIN number for a vehicle of the motor carrier that will transport the predetermined load responsive to the load level compliance record for the motor carrier;
determining if the vehicle of the motor carrier is insured to transport the predetermined load responsive the VIN number for the vehicle and insurance data for the motor carrier; and
granting the predetermined load to the motor carrier responsive to the determination of whether the vehicle of the motor carrier is insured to transport the predetermined load.
